(19) United States
(12) Patent Application Publication
(10) Pub. No.: US 2013/0290155 A1
(43) Pub. Date: Oct. 31, 2013

(54) SYSTEM AND METHOD FOR PROCESSING DATA RELATED TO FIXED ANNUITIES HAVING PRICE INDEX BASED INTEREST CREDITING

(71) Applicants: Brian J.J. Wilson, Ellington, CT (US); Glenn J. Gazdik, Suffield, CT (US); Xiaobo Zhou, Simsbury, CT (US)

(72) Inventors: Brian J.J. Wilson, Ellington, CT (US); Glenn J. Gazdik, Suffield, CT (US); Xiaobo Zhou, Simsbury, CT (US)

(73) Assignee: HARTFORD FIRE INSURANCE COMPANY, Hartford, CT (US)

(21) Appl. No.: 13/455,939

(22) Filed: Apr. 25, 2012

(51) Int. Cl. G06Q 40/06

(52) U.S. Cl. 705/35

(57) ABSTRACT

A computer system for processing data related to fixed annuities includes: one or more data storage devices storing data associated with fixed annuities and indicative of account values, a time period for crediting of interest; and a crediting method including for each of the fixed annuities one of at least an equity index based crediting method and a price index based crediting method; and an annuity administration hardware server configured to: receive price index value data, determine a price index crediting rate for each of the fixed annuities having a price index based crediting method based on the received price index value data, a threshold value of the price index, a participation rate, and the guaranteed rate; and calculate updated account values using the price index crediting rate and the account values;

### FIELD OF INVENTION

The present invention relates to computer systems, and particularly to computer systems for use in the financial services field, and particularly for processing of data related to fixed annuities.

### BACKGROUND

Fixed annuities are in the form of contracts between an annuity owner and an issuing insurance company. In such annuities, an account is established with an initial account value based on a premium paid by the annuity owner. On a periodic basis, amounts are credited to the account. In some fixed annuities, the amount credited is an interest rate on the account balance. The interest rate is often determined by the insurance company based on market conditions. In some instances, a minimum guaranteed interest rate is specified in the contract for a period of years following issue of the annuity contract.

In fixed index annuities, the amount credited, rather than being based on an interest rate determined by the insurance company or specified in the annuity contract, is based on an increase in a value of an index over a time period. For example, the index may be an index of equity securities, such as an index of stocks traded on one or more exchanges. If the value of the index declines during the time period, then the annuity account value remains the same. Thus, the owner of a fixed index annuity does not bear the risk of loss of annuity value as a result of loss of value of the index. There are various manners of determining crediting. In one manner, called point to point, the percentage change in index value is obtained between two dates, such as a current anniversary of the annuity contract and prior anniversary of the annuity contract. The percentage increase in index value is credited to the account, generally up to a percentage cap. The amount credited is in some products limited by a participation rate to a percentage of the gain. For example, in a fixed index annuity with a cap of 4% and a participation rate of 80%, a credit of 4% will be provided based on an index gain of 5% or greater between the two dates.

Certain fixed index annuities provide interest crediting based on a performance trigger strategy. In a performance trigger strategy, if the change in the index value between the two dates is zero or positive, then a preset interest credit percentage is applied. If the change in the index value between the two dates is negative, in a performance trigger strategy, then there is no change in the index value. The interest credit percentage may be specified in the annuity contract, set at intervals by the issuing insurance company in its discretion, or set by the insurance company subject to limits, such as a minimum value, specified in the annuity contract.

Systems that implement processing of data related to fixed annuities with protection against greater than average inflation would be desirable.

### SUMMARY

In an embodiment, a computer system for processing data related to fixed annuities includes one or more data storage devices storing data associated with a plurality of fixed annuities and indicative of account values, a time period for crediting of interest, a crediting method including for each of the fixed annuities one of at least an equity index based crediting method and a price index based crediting method; and for each of the fixed annuities having an associated price index based crediting method, a participation rate, a threshold value of the price index increase, and a guaranteed rate. The system further includes an annuity administration hardware server, in communication via a network with sources of data as to price index values and equity index values, and configured to: determine a price index crediting rate for each of the fixed annuities having a price index based crediting method based on the received price index value data, the threshold value, the participation rate, and the guaranteed rate; calculate an updated account value for each of the fixed annuities having a price index based crediting method based on the price index crediting rate and the account values; and provide output data indicative of the updated account value. The system further includes a webserver in communication with the annuity administration server configured to receive at least the updated account value data and to permit a client device to access the updated account value data for display to a user.

In an embodiment, the annuity administration server is further configured to determine whether the threshold value of the price index value has been reached, and, responsive to determining that the threshold value of the price index value has not been reached, set the price index based crediting rate equal to the guaranteed rate, and responsive to determining that the threshold value of the price index value has been reached, determine the price index based crediting rate by multiplying the participation rate by the price index value and adding the guaranteed rate to a result of the multiplying.

In an embodiment, the annuity administration hardware is further configured to determine an equity index crediting rate for each of the fixed annuities having an equity index based crediting method based on the received equity index value data; and calculate an updated account value for each of the fixed annuities having an equity index based crediting method based on the equity index crediting rate and the account values.

In an embodiment, a computer-implemented method for processing data includes receiving by an annuity administration hardware server via a network data indicative of price index values; accessing by the annuity administration hardware server one or more data storage devices storing data associated with a plurality of fixed annuities and indicative of account values, a time period for crediting of interest, a crediting method including for each of the fixed annuities one of at least an equity index based crediting method and a price index based crediting method; and for each of the fixed annuities having a price index based crediting method, a participation rate, a threshold value of the price index increase, and a guaranteed rate; determining by the annuity administration hardware server, for the time period for crediting of interest, for each of the fixed annuities having a price index based crediting method, a price index based crediting rate based on the received price index value data, the threshold, the participation rate, and the guaranteed rate; calculating by the annuity administration hardware server an updated account value for each of the fixed annuities having a price index based crediting method based on the determined price index based crediting rate; and providing by the annuity administration hardware server to a client communication system output data indicative of the updated account value.

In an embodiment, a non-transitory computer-readable medium has processor-executable instructions stored thereon relating to processing of data for fixed annuities, which instructions, when executed by the processor, cause the processor to: receive via a network data indicative of price index values; access one or more data storage devices storing data associated with fixed annuities and indicative of account values, a time period for crediting of interest, a crediting method including for each of the fixed annuities one of at least an equity index based crediting method and a price index based crediting method; and for each of the fixed annuities having a price index based crediting method, a participation rate, a threshold value of the price index increase, and a guaranteed rate; determine, for the time period for crediting of interest, for each of the fixed annuities having a price index based crediting method, a price index based crediting rate based on the received price index value data, the threshold, the participation rate, and the guaranteed rate; calculate an updated account value for the each of the fixed annuities having a price index based crediting method based on the determined price index based crediting rate and the stored account value; and provide to a client communication system output data indicative of the updated account value.

### BRIEF DESCRIPTION OF DRAWINGS

FIG. 1 is a schematic diagram showing a computer system for processing data related to fixed annuities having returns dependent on inflation in an environment in which such a system may be implemented.

FIG. 2 is displays a client device and associated system components in an implementation of a method and system of the invention.

FIG. 3 is a schematic diagram of an exemplary computer system for implementation of a method and system of the invention.

FIG. 4 is a schematic diagram of an exemplary computer server, databases and networked devices for implementation of a method and system of the invention.

FIG. 5 is an exemplary screen display on a user device in connection with a system and method of the invention.

FIG. 6 is a process flow diagram of data processing steps performed by a computer system in an embodiment of a system of the invention.

### DETAILED DESCRIPTION

It is to be understood that the figures and descriptions of the present invention have been simplified to illustrate elements that are relevant for a clear understanding of the present invention, while eliminating, for the purpose of clarity, many other elements found in typical computer systems and methods for processing of data relating to annuities, including fixed annuities. Those of ordinary skill in the art may recognize that other elements and/or steps are desirable and/or required in implementing the present invention. However, because such elements and steps are well known in the art, and because they do not facilitate a better understanding of the present invention, a discussion of such elements and steps is not provided herein.

In fixed annuities, including fixed index annuities, there is a risk of loss of purchasing value of an account as a result of greater than average inflation. For example, during certain time periods, equity market performance may fail to match the rate of inflation, measured, for example, by an index indicative of purchasing power of consumers, such as a consumer price index. During a period of low consumer price inflation, potential purchasers of equity index annuities may, in evaluating whether to purchase equity index annuities, may consider the effect of possible future inflation on various investment products. For example, short term or medium term Treasuries, some certificate of deposits, corporate bonds and similar products expire or permit sales within a relatively short term of less than a year or two years. During a period of rising inflation, such products expire thus expire or can be sold, with the proceeds reinvested in similar products with higher rates, as interest rates on such products are relatively quickly responsive to changes in the general interest rate environment. Historically, such products have generally provided a hedge in periods of higher than average inflation.

Fixed annuities such as fixed index annuities typically have a term generally of at least five years and in some cases 7 years, 10 years or more. During a period of time after purchase of an index annuity contract, such as a five year or seven year term, withdrawals in excess of an annual free out amount or percentage are subject to a surrender charge. A surrender charge is a reduction in contract value equal to a percentage of funds withdrawn in excess of an available free withdrawal amount. The surrender charge percentage may be a declining percentage, with no surrender charges applied after a period of years, such as commencing on the sixth or eighth anniversary of fixed index annuity contract. Some fixed annuities are also subject to market value adjustments, which change the contract value if a withdrawal in excess of an available free withdrawal amount is made, for example. The amount of a market value adjustment may depend on current interest rates and the number of years remaining in the term of the annuity. If current interest rates are higher than interest rates applicable to the annuity, the market value adjustment will generally result in a reduction in contract value. As a result of the surrender charges and market value adjustments, in an environment of above average price inflation and increasing interest rates, investors in fixed index annuities are faced with a choice between leaving funds in the fixed index annuities, with a risk of erosion of purchasing power depending on equity index performance, or withdrawing the funds and experiencing a reduction in account value due to surrender charges and/or market value adjustments.

Over the time period from about 1950 to the present, equity indexes have generally outperformed the rate of inflation, when compared over time periods of five years and up. However, equity index performance does not always outperform the rate of inflation, even over multi-year periods. For example, in the late 1970's and early 1980's, inflation rates were historically high for the United States, and returns on well-known indexes based on U.S. equity holdings did not keep pace. For example, from January 1976 to January 1981, the S&P 500 index increased in value by about 30%. The Consumer Price Index for Urban consumers (CPI-U), maintained by the Bureau of Labor Statistics, increased by over 50% in that time period.

In an embodiment, a system for processing data related to a fixed index annuity is configured to determine an amount for crediting to an account responsive to data indicative of consumer price increases. The system relates to processing data for a fixed index annuity contract between an insurance company and a contract owner. The system may be configured to provide for crediting the account based on a consumer price index only if the consumer price index change exceeds a threshold value. By limiting crediting based on a consumer price index to those periods when the increase exceeds a threshold value, the insurance company avoids a need to pay interest based on typical levels of inflation, such as inflation levels of around 3% per year, while the investor is protected against higher than average inflation rates. The threshold may be in the range from 2% to 6%, inclusive, by way of example. The system may be configured to pay a base or guaranteed rate if the inflation rate for the period is below the threshold. The base rate may be between 0.5% and 2%, or between 0 and 2%, for example. The base rate may be set in the annuity contract, or may be determined by the insurance company on a periodic basis in its discretion. The annuity contract may set a minimum base rate, and systems for implementing the invention may be configured to prevent a user from manually adjusting a base rate below a minimum base rate stored in a database and associated with the annuity contract.

The system may further be configured to provide crediting based on the entire inflation rate or a portion of the inflation rate, e.g., the amount by which the inflation rate exceeds the threshold. The system may be configured to provide crediting based on the inflation rate adjusted by a participation rate. For example, the participation rate may be a percentage of greater than 0 and not more than 150% of the inflation rate and may be between 40% and 125%, inclusive, or 50% and 125%, inclusive.

The inflation rate may be measured according to a price index, such as one of the consumer price indices maintained by the Bureau of Labor Statistics, such as the CPI-U. Other consumer price indices may be employed, including others developed by the Bureau of Labor Statistics.

A system may be configured to permit an owner of a fixed annuity to select one of several crediting methods for time periods during a term of the fixed annuity. For example, the system may be configured to determine crediting based on one of a point to point method with a cap based on an equity index, a performance trigger based on the equity index, a fixed rate, and a consumer price index linked rate. The system may be configured to permit the owner to change the selected method of crediting on a periodic basis, such as on an annual basis or other time period.

A factor in availability of price indices may be the availability of financial instruments that the insurance company can purchase to hedge the risk of paying additional interest in the event of inflation above the threshold. For example, options are generally available with payouts depending on CPI-U performance for one year, two year and three year time periods.

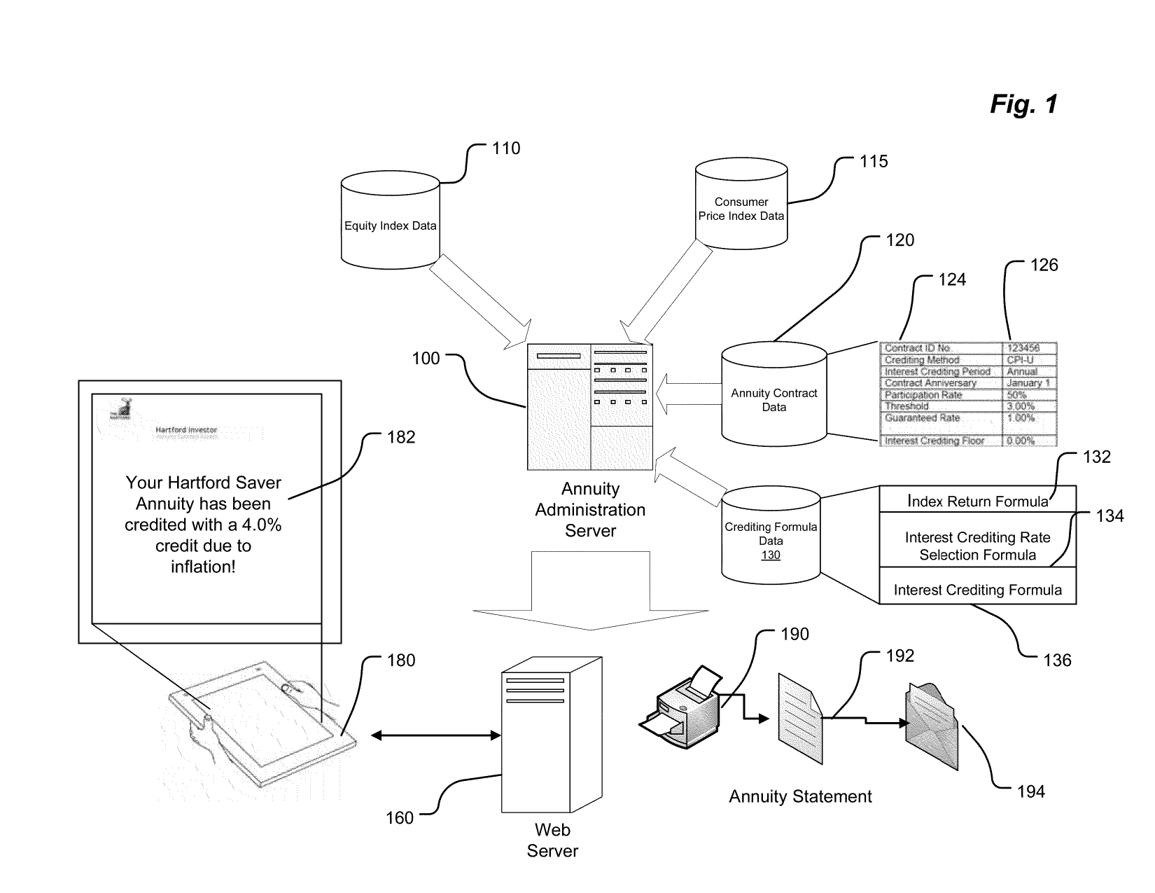

Referring now to FIG. 1, an embodiment of a system for processing data related to fixed index annuities and configured to credit interest to the annuities based on an inflation index will be described. Annuity administration server 100 is a computer system configured to receive and store data related to fixed index annuities and to process data related to fixed index annuities. Annuity administration server 100 receives data relating to index performance from equity index database 110. Equity index database 110 is an exemplary database having data indicative of at least values of at least one equity index on a plurality of dates, including, for example, all business days for a time period and up to and including the immediate past business day. The equity index value may be the equity index value as reported by an index administrator, such as Standard & Poor's for the S&P 500 equity index, as of a close of markets for each business day. Other equity indexes, such as the Dow Jones Industrial Average, various versions of the Wilshire 4500 Completion Index and Wilshire 5000 Total Market Index, and other U.S. market, other country market (e.g., the FTSE 100 Index for companies listed on the London Stock Exchange), multi-country indexes (e.g., the S&P Global 1200 Index), by way of example, may be used. Each equity index value is associated with a date. In embodiments, the data indicative of equity index value and associated date may be accessed, such as via an ftp server using suitable credentials, by annuity administration server 100, or may be delivered on an automated basis via suitable data transfer protocols to annuity administration server 100. The equity index value and date data may be delivered on a periodic basis and stored by annuity administration server 100 in a local data storage device or may be accessed by annuity administration server 100 on an as needed basis.

Annuity administration server 100 may be a server configured to process and store data for a plurality of annuity contracts during the accumulation phase. As such, annuity administration server 100 is configured to receive data relating to annuity contracts, including type of annuity, contract owner, death benefit formula, beneficiary of death benefits, premiums paid (including amount and date), annuity term, free withdrawal amounts or percentages and associated times, contract dates, market value adjustment formulas and surrender charges. The stored data may further include an interest crediting strategy associated with each annuity during a current time period. The available values of the interest crediting strategy may include point to point method with a cap based on an equity index, a performance trigger based on the equity index, a fixed rate, and a consumer price index linked rate. The stored data associated with each of the annuities may further include periods for changing interest crediting strategies, and data indicative of formulas to determine and update account values.

Annuity administration server 100 is further in communication with inflation index database 115. Inflation index database 115 may maintain data indicative of an inflation index value and associated date data. For example, inflation indexes may be one of the consumer price indexes (CPI) issued by the U.S. Bureau of Labor Statistics on a periodic basis. One example of such an index is the “All Items Consumer Price Index for All Urban Consumers” (CPI-U). A value for this index is issued on a monthly basis. There are thousands of other indexes which may be used. These indexes are based on surveys of prices for various goods and services, and weighting of the price survey data to include in an index. The goods and services included in the survey may be referred to as a market basket of goods and services for the index. Different indexes employ different goods and services in the market basket, and/or different weightings of the goods and services in the index. Another exemplary index is the CPI-E, which is an experimental price index for Americans 62 years of age or older, having a market basket intended to reflect purchases of Americans 62 years of age and older better than the CPI-U. For example, an index intended to reflect purchases of Americans 62 years of age and older may weight health care services more heavily than an a general index, and may weight education services less heavily. Inflation index database 115 may be maintained on computer systems of a third party, such as a government agency, of a third party that aggregates government data, or on data storage devices used by the insurance company, such as locally to annuity administration server 100, via networked connection to annuity administration sever 100, or in third party resources, such as third party resources described as the cloud or by similar nomenclature.

Annuity administration server 100 is further in communication with annuity contract database 120. Database 120 may include data stored in local data storage devices associated with annuity administration server 100, data storage devices in communication via a network, e.g. local area network (LAN) or wide area network (WAN) of the insurance company with annuity administration server 100, or data stored in one or more third party data storage devices accessible employing the cloud.

Table 122 displays exemplary data associated with a fixed index annuity contract in annuity contract database 120. Column 124 displays exemplary fields of data associated with an annuity contract in annuity contract database 120. Exemplary data fields include a contract identifying alphanumeric identifier, a crediting strategy, a time period for crediting of interest, a contract anniversary date, a participation rate, a threshold value of the price index increase to trigger application of the price index, a guaranteed rate to be applied if the threshold is not met, and an interest crediting floor. Column 126 displays exemplary data values for each of these data fields. The crediting strategy is identified by CPI-U, which is an inflation index. The interest crediting period is annual, although the period could be any other time period consistent with the price index value. For example, as the CPI-U is issued on a monthly basis by the BLS, the interest crediting period may be any multiple of a month, such as monthly, three months or six months. For a price index value issued on a different cycle, such as quarterly, annually or weekly, the available interest crediting periods may be limited or alternatives may be available.

The contract anniversary date shown is January 1. The contract anniversary is employed for determining, along with the interest crediting period, the dates of price index values to be used in determining account crediting, along with the dates interest based on price index values may be credited to the account. The contract anniversary date is also employed in determination of time periods for withdrawals not subject to a surrender charge, applicable surrender charge rates, and annuity expiration dates, for example.

The exemplary participation rate is 50%; the exemplary threshold is 3.00%; the guaranteed rate is 1.00% and the interest crediting floor is 0.00%. These rates may be fixed at issue of an annuity and unchanged for the term of the annuity, or may be subject to periodic revision by the insurance company, e.g., on the contract anniversary date.

Annuity administration server 100 is further in communication with crediting formula database 130. Crediting formula database 130 includes data indicative of formulas including an index return formula 132, an interest crediting rate selection formula 134, and an interest crediting formula 136. Crediting formula database may be implemented as one or more spreadsheets incorporating formulas in a suitable format, such as formats compatible with the Microsoft Excel® spreadsheet software. In other embodiments, the formulas of the crediting formula database may be incorporated in computer program code executed by annuity administration server 100. The formulas may be incorporated in modules of code that are called by a processor executing computer program code as needed. Annuity administration server 100 is configured to access formulas from crediting formula database 130, populate the accessed formulas using data accessed from annuity contract database 120, inflation index database 115 and equity index database 110, and perform calculations to determine results of the accessed formulas, including crediting interest to fixed annuity account values based on consumer price index data.

The index return formula 132 may, in one embodiment, be the following:

$$\frac{EndingIndexLevel}{InitialIndexLevel} - 1 = IndexReturn$$

This calculation is performed by annuity administration server 100 at the end of an index crediting period. An index crediting period has a length set by the value of the interest crediting period, and a termination date depending on the contract anniversary date. In the above equation, the Initial Index Level is the value of the index, such as the CPI-U, released in the month prior to the first date of the expiring index crediting period. The Ending Index Level is the value of the index released in the month prior to the last day of the expiring index crediting period. Thus, using the CPI-U index, which is released once each calendar month, generally mid-month, a contract anniversary date of February 1, and a one year index crediting period, the initial index value is the CPI-U value provided by BLS in the January prior to the expiring index crediting period (e.g., January 2012 CPI-U value for the initial index level, and January 2013 CPI-U value, for an index crediting period expiring Feb. 1, 2013). As the BLS does not necessarily release the CPI-U value on the same date each month, use of the preceding month's CPI-U value provides certainty as to the CPI-U value employed. In other embodiments, other methods of selection of the CPI-U value may be used, e.g., using the current month's CPI-U value for annuities having a contract anniversary after a certain date, such as the 20^{th}, of each month, and otherwise using the prior month's CPI-U value. For indexes released on a different schedule, or different crediting periods, other suitable formulas for determination of the date of the index used for index return calculations may be implemented.

As a step in processing the index crediting formula, the system may access an index crediting rate selection formula. The index crediting rates for selection include the guaranteed rate and a rate based on the inflation index return. The index crediting rate selection formula may provide for comparison of calculated index return to the threshold. Responsive to determining that the inflation index return is below the threshold, the system, in accordance with the interest crediting rate selection formula, then determines index crediting based on applying the guaranteed rate. Responsive to determining that the inflation index return is at or above the threshold, the system, in accordance with the interest crediting rate selection formula, then accesses a further formula. In this formula, the factors include the inflation index return and the participation rate. In an embodiment, the interest crediting rate may be:

(IndexCreditingRate)=(GuaranteedRate)+(ParticipationRate)×(IndexReturn)

An interest crediting formula 136 may be the account value multiplied by the index crediting rate.

The example below, in Table 1, shows the operation of an embodiment of a system:

TABLE 1

| | Index | Base | Additional | Interest |
|---|---|---|---|---|
| | Return | Rate | interest | Credit |
| Year 1 | −3.13% | 0.50% | 0.00% | 0.50% |
| Year 2 | 2.00% | 0.50% | 0.00% | 0.50% |
| Year 3 | 3.00% | 0.50% | 3.00% | 3.50% |
| Year 4 | 6.00% | 0.50% | 6.00% | 6.50% |

The example of Table 1 is based on a guaranteed rate of 0.5%, a participation rate of 100%, and a threshold of 3.00%. Thus, in years 1 and 2, with the index return, i.e., the rate of inflation, below 3.00%, the interest credit is equal to the base rate. In years 3 and 4, the inflation rate is equal to and then above the threshold. Accordingly, the interest credit is equal to the sum of the base rate and the inflation rate. Thus, if the inflation rate exceeds the threshold, the entire rate of inflation is applied to the participation rate to determine the amount credited.

Continuing to refer to FIG. 1, the annuity administration server 100 determines the credited amount, based on the interest crediting formula. For example, taking the assumptions of Table 1, for Year 3, and further assuming an account value of $100,000, a total of $500 is credited to the account value.

The threshold value may be between 2% and 6%, for example. The threshold value may be set by the insurance company on a periodic basis, such as for each crediting period for each annuity, or may be fixed for an annuity term. The threshold value may be selected based on factors including a cost of options or other derivatives purchased by the insurance company, which derivatives provide for payment by a counterparty to the insurance company based on price indexes, the payments increasing generally with greater price index increases. The threshold value may be selected by the insurance company in its discretion upon selection by an annuity owner of the price index based crediting method for the next upcoming crediting period. In other embodiments, the threshold value may be a calculated value using a formula including a price of options that provide payments at the end of an option term dependent on CPI-U or other price index. In embodiments, the participation rate may be selected, in addition to or as an alternative to selection of the threshold, periodically as described, and may be based on a formula including a price of options that provide payments at the end of an option term dependent on CPI-U or other price index.

The crediting based on a price index may be available without payment of a rider charge or other charge against account value.

The data as to crediting rate and amount credited is stored in annuity contract database 120 by annuity administration server and is provided to the annuity owner via a client communication system. Client communication systems may include webservers and printed statement generation systems, and may be configured for generation and communication to users of printed and electronic messages, statements and reports. A user, such as an annuity owner or co-owner, annuitant, or broker or other financial advisor of an owner or may, after suitable authentication, may access data via a networked user device, such as tablet computer 180, in communication with web server 160. Webserver 160 in turn fetches data related to the annuity associated with the user from annuity administration server 100, renders the data in a suitable format, such as using appropriate html code, selects a suitable template, populates the template with suitable data and template images, and provides the suitable image for display on a user device such as tablet computer 180. In the depicted image, the image includes a message 182 advising of the crediting rate based on the price index increase. However, this message is merely exemplary, and other data related to the annuity or annuities associated with the owner, such as account value, crediting rates based on equity index increase, available free out amounts or percentages, and other data may be displayed.

The client communication system may be a statement printing system including a plurality of printers 190 for printing annuity statements 192, which statements are formatted to include data determined by annuity administration system 100, such as contract number, owner name, anniversary date, account value, crediting strategy, crediting rates based on guaranteed rates or inflation index increases, crediting rates due to equity index performance (for time periods during which an equity index strategy has been selected by an annuity owner), credited amounts based on crediting rates, term, surrender charges and rates for surrender charges, premium amounts paid, and other data. Systems for printing, folding, envelope stuffing and application of postage using automated postage meters may be employed, supplied by Neopost or other vendors.

Annuity administration server 100 is configured for administration of fixed annuities during the accumulation phase. An annuity during the accumulation phase may also be referred to as “unannuitized.” During the accumulation phase of an annuity, in general, the annuity has an account value available to the owner for withdrawal, subject to surrender charges and market value adjustments. Any payments made to the owner during the accumulation phase are generally by way of withdrawal, which withdrawal reduces the account value. If no withdrawals are made, as interest is credited, the account value of the annuity increases.

The accumulation phase of a fixed annuity ends upon annuitization. At annuitization, the account value is converted to a guarantee of a stream of payments, and the payout phase of the annuity commences. The ratio between the account value at annuitization and the amount of annual payments is generally referred to as the payout rate. The payout rate is generally set by the insurance company, in accordance with the annuity contract, which may provide minimum payout rates. Payout rates vary depending on term of payments (e.g., for set term of years, for life a single annuitant, for last to die of two annuitants); actuarial data of the annuitant or annuitants, such as age and gender; timing of payments, such as annual, quarterly and monthly, and other factors. Upon annuitization, the annuity ceases to have an account value available for withdrawal by the owner. Annuitization may be selected by an owner in the discretion of the owner, although, depending on the length of time since the annuity was issued and contract terms, surrender charges and market value adjustments may be applied to an account value prior to determination of payout amounts. In some annuities, annuitization is required upon an account owner or an annuitant reaching a certain age.

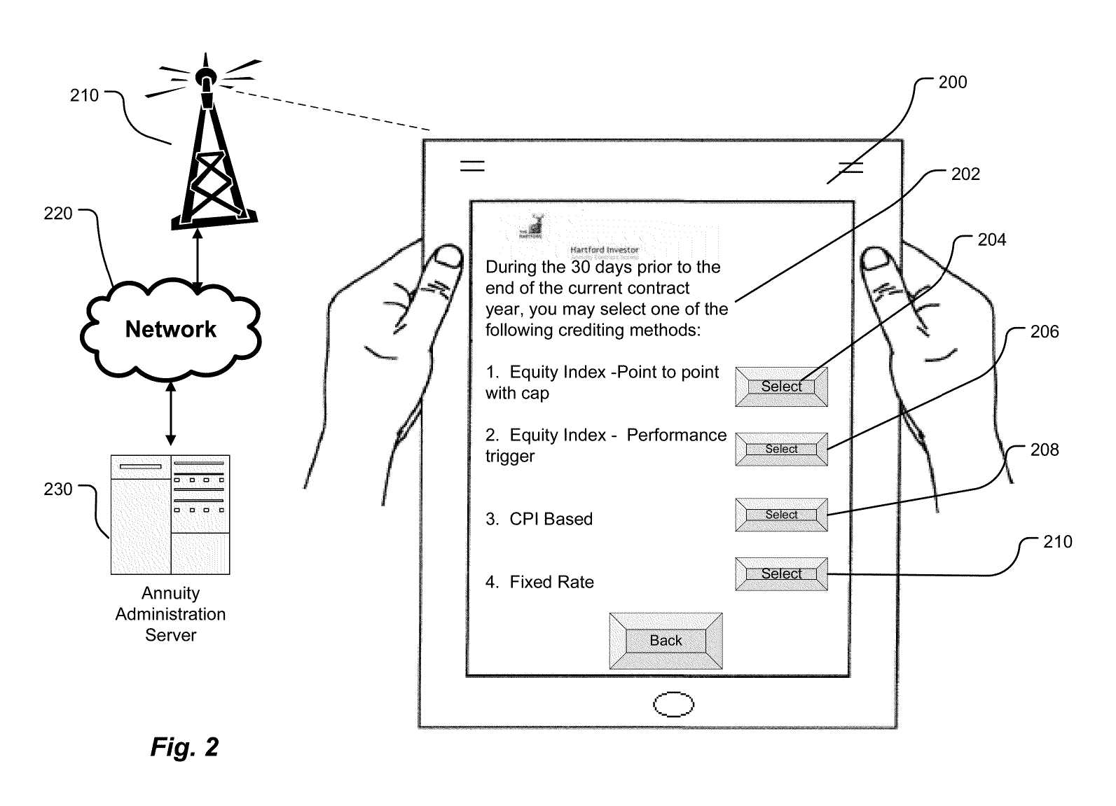

Referring to FIG. 2, an exemplary system of an embodiment of the present invention is shown, showing a screen displayed on a user device. In one embodiment, a user operates a device 200, such as a touch screen type device for viewing and accessing information and data related to their allowance and diversionary accounts as described herein. Touch screen device 200 can be an active sensor employing capacitive, resistive, inductive, or other methods, or it can be a passive surface on which touch sensing is accomplished by optical, acoustic, or other similar methods. Device 200 can also include a liquid crystal display (LCD), organic light emitting diode (OLED) display, electroluminescent display, or any other type of small display suitable for mounting in a portable computer or mobile device. Device 200 may be color or monochrome, and may include a backlight capability to enhance readability in various lighting conditions.

Device 200 may receive web document 202 via wireless connection via wireless network 210, which is in communication via network 220, which may be the Internet, with annuity administration server 230. Web document 202 displays prompts for a user to select a crediting method for the next upcoming crediting period, e.g., a one year period between anniversaries of the issue date of the annuity. The web document includes buttons 204, 206, 208, 210 for permitting a user to send data to annuity administration server 230 for selection of a crediting method for the next upcoming crediting period. The displayed available selections are (1) equity index based using point to point with cap methodology; (2) equity index based using performance trigger crediting; (3) price index based crediting; and (4) fixed rate crediting. Upon receipt of data indicative of the selection, annuity administration server 200 may update data records related to the annuity to include data indicative of the selected crediting methodology. Other crediting methodologies may be made available in embodiments.

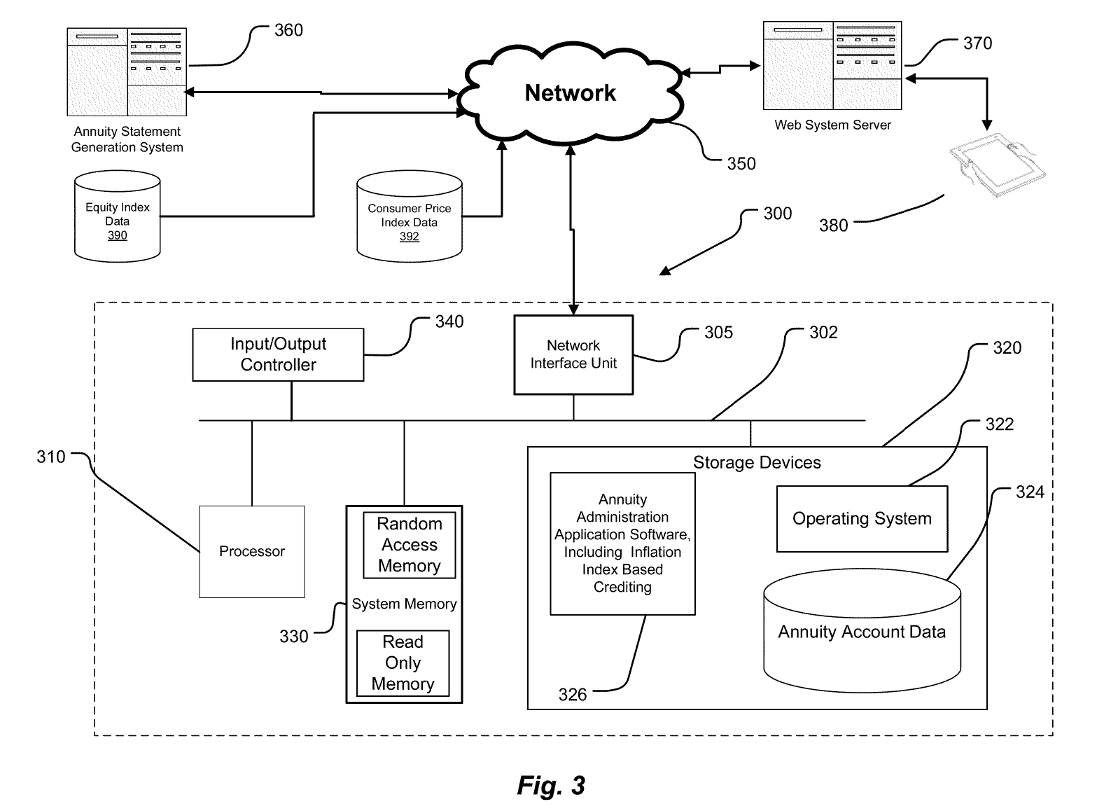

Referring to FIG. 3 an exemplary computer system 300 for use in an implementation of the invention will now be described. In computer system 300, processor 310 executes instructions contained in programs fixed index annuity with inflation index crediting application software 326, stored in storage devices 320. As used herein, the term “processor” broadly refers to and is not limited to a single- or multi-core general purpose processor, a special purpose processor, a conventional processor, a Graphics Processing Unit (GPU), a digital signal processor (DSP), a plurality of microprocessors, one or more microprocessors in association with a DSP core, a controller, a microcontroller, one or more Application Specific Integrated Circuits (ASICs), one or more Field Programmable Gate Array (FPGA) circuits, any other type of integrated circuit (IC), a system-on-a-chip (SOC), and/or a state machine. Application program 326 may include separate modules for such functions as prompting a user, such as an insurance company employee, to input required data for initial setup of a new annuity account, including selection of an initial equity index based, inflation index based or fixed rate crediting methodology, and to perform verification of completeness and consistency of provided information, assigning contract numbers to new annuity contracts, retrieving equity index data and consumer price index data, determining interest crediting based on equity index data, determining interest crediting based on consumer price index data, including use of threshold values, guaranteed or base rates, participation rates, and the like, determination and updating of account values, exchanging data with other systems, such as policy document generation systems, systems for administration of annuities during a payout phase, accounting systems; generation of statements; furnishing of data to printing and mailing systems, web servers and other systems for client communications; illustration calculation and generation systems; processing of withdrawals, including calculation of surrender charges and market value adjustments; determination of death benefits; and other functions. Storage devices 320 may include suitable non-transitory computer-readable media, such as optical or magnetic disks, fixed disks with magnetic storage (hard drives), flash memory, tapes accessed by tape drives, and other storage media. Processor 310 communicates, such as through bus 302 and/or other data channels, with network interface unit 305, system memory 330, storage devices 320 and input/output controller 340. Via input/output controller 340, processor 310 may receive data from user inputs such as pointing devices (including mice and trackballs), touch screens, audio inputs and keyboards, and may provide data to outputs, such as data to video drivers for formatting on displays, data to print drivers for transmission for printing in hard copy or to image files, and data to audio devices.

Storage devices 320 are configured to exchange data with processor 310, and may store programs containing processor-executable instructions, including instructions for implementing calculations employing algorithms, such as algorithms for determining interest crediting rates based on consumer price index changes, and values of variables, such as consumer price index values and associated dates, dates of beginning and ends of crediting periods, threshold increase values, participation rates and base rates, for use by such programs. Processor 310 is configured to perform steps in accordance with such processor-executable instructions. Processor 310 is configured to access data from storage devices 320, which may include connecting to storage devices 320 and obtaining data or reading data from the storage devices, or storing new and updated data into the storage devices 320. Storage devices 320 may include local and network accessible mass storage devices. Storage devices 320 may include media for storing operating system 322 and mass storage devices such as annuity account data storage device 324 for storing data related to annuities, account owners, beneficiaries, and the like. Such data may include data described with reference to annuity contract database 120 of FIG. 1, for example.

Still referring to FIG. 3, in an embodiment, inputs may include user interfaces, including workstations having keyboards, touch screens, pointing devices such as mice and trackballs, or other user input devices, connected via networked communications to processor 310. Network interface unit 305 may communicate via network 350 with other insurance computer systems, such as systems for generating payments of withdrawals, payments of death benefits, and administration of annuities during the payout phase.

Network interface unit 305 may further communicate with computer systems of the insurance company, such as annuity statement generation system 360 and websystem server 370, as well as computer systems of other entities, such as brokers and other financial advisers of annuity owners. Network interface unit further permits receipt via network 350 of equity index data 390 and consumer price index data 392 from remote sources. Annuity statement generation system 360 may be configured for using template forms and received or accessed data stored in annuity account database 324 for creation of electronic and hard copy annuity statements, showing interest crediting, account values and other data related to annuities. The web system server 370 may generate web documents for display on consumer device 380, including data contained in reports, images of reports generated by annuity statement generation system 360, and other annuity-related data. In embodiments, a user from device 380 may send instructions via web system server 370 and network interface unit 305 to cause system 300 to take actions, such as processing withdrawals, calculation of surrender charges, selecting crediting methodologies, and other actions.

In other embodiments, the functions of annuity statement generation system 360 may be incorporated in the functionality of computer system 300.

Network 350 may be or include wired or wireless local area networks and wide area networks, and over communications between networks, including over the Internet. Any suitable data and communication protocols may be employed.

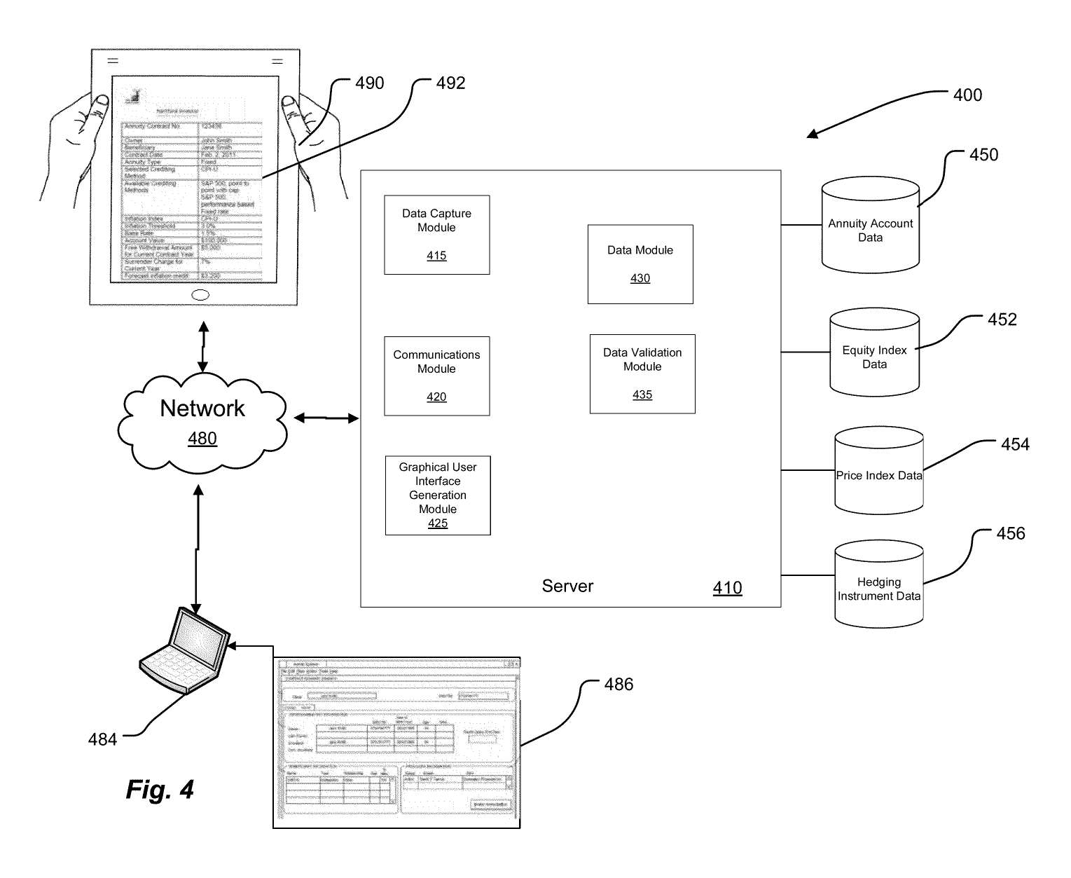

Referring now to FIG. 4, another exemplary embodiment of a system 400 of the present invention is shown. System 400 includes an insurance company hardware server 410 which includes one or more engines or modules which may be utilized to perform one or more steps or functions of embodiments of the present invention. In an embodiment, the present invention is implemented as one or more modules of a computer software program in combination with one or more components of hardware. Such software programs will be used when a system user, such as an insurance company employee, or an annuity owner or representative, has sent a request for data or information to a server and comprises part of the processing done on the server side of the network. Such software programs may also operate, such as on a daily basis, to perform batch processing of data related to annuities. For example, a daily batch run may include identifying all annuity contracts that have reached a date for calculation of interest, and performing of calculation of crediting rates, application of crediting rates to account values, and determination of updated account values. The programs may be used in an Internet environment, where the server is a Web server and the request is formatted using HTTP (or HTTPS). Alternatively, the server may be in a corporate intranet, extranet, or any other type of network. Use of the term “Internet” herein, when discussing processing associated with the user's request, includes these other network environments, unless otherwise stated. Additionally, a graphical user interface or other module may be implemented as an intelligent hardware component incorporating circuitry including custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like. One or more functions of a web client or other module may be implemented as application software in the form of a set of processor-executable instructions stored in a memory of a client device, such as tablet computer 490 or laptop 484, and capable of being accessed and executed by a processor of the client device.

Referring still to FIG. 4, server 410 includes a data capture or input/output module 415, a communications module 420, a dynamic display generation or graphical user interface module 425, a data module 430, and a data validation module 435. Data module 430 is in further communication with a number of databases such as annuity account database 450, equity index database 452, consumer price index database 454 and hedging instrument database 456. Databases 450, 452, 454, 456 may be implemented in one or more physical data storage devices in communication with server 410, or may be implemented in remote data storage devices accessible over one or more networks, such as cloud computer servers accessible via the Internet. Databases in communication with server 410 may include both internal and/or external/third party databases. By way of example, external databases may include databases maintained by government agencies and commercial entities providing price index data, financial services data providers furnishing equity index value data, and financial services entities providing data relating to terms and prices of hedging instruments, such as options having payouts at future dates dependent on values of one or more consumer price indexes. Server 410 may be configured for bulk upload of data, such as bulk upload of equity price index data on a daily basis, for systems having annuities based on more than one equity price index. Such data may be furnished such as via a spreadsheet file or via suitable xml documents, by way of example. Data may be exchanged between server 410 and one or more legacy systems via suitable middleware systems. One or more modules, such as data validation module 435, may be configured to perform data validation steps prior to storing bulk uploaded data. Server 410 may further be configured to permit bulk download of data, such as annuity data of clients of a broker or financial services retailer, to a device of suitably-authorized user.

In operation, server 410 is in communication with client devices, such as laptop computer 484 or tablet computer 490 via network 480 which facilitates interaction with server 410 through one or more graphical user interfaces as shown and described herein. As used herein, devices, such as client devices 484, 490 may exchange information via any communication network, such as a Local Area Network (LAN), a Metropolitan Area Network (MAN), a Wide Area Network (WAN), a proprietary network, a Public Switched Telephone Network (PSTN), a Wireless Application Protocol (WAP) network, a Bluetooth network, a wireless LAN network, and/or an Internet Protocol (IP) network such as the Internet, an intranet, or an extranet. Note that any devices described herein may communicate via one or more such communication networks.

Referring still to FIG. 4, utilizing client devices 484, 490, a properly authenticated system user, such as an annuity owner or financial advisor, may view annuity data, and initiate annuity transactions, such as selection of crediting methods, withdrawals, premium payments and generation of printed statements. By way of example, display 492 may be provided showing data relating to an annuity, including a result of a calculation of a forecast inflation credit based on projecting monthly price indexes for the entire year using a suitable algorithm, e.g., level increases for remainder of year based on most recent three or greater number, or projecting a level rate of increase based on rates of increase for most recent monthly reports, such as the most recent six months. This may be calculated using a module running on server 410, or an application program running on tablet computer 490. An application program running on tablet computer 490 may be further configured to prompt a user for available actions, such as generating forecasts of future account value based on various assumptions as to equity index returns and inflation, permitting instructions for withdrawals, instructions for change of beneficiary, determination of death benefit amount based on a selected exemplary date of death of the owner, and other actions. Data indicative of instructions input by a user on tablet computer 490 may be uploaded to server 410, which then may implement the instructions in accordance with processor-executable instructions. Alternatively, server 410 may be configured to generate data indicative of web documents for display on device 490 to verify instructions prior to commencement of processing. Server 410 may further generate data for transmission to device 490 which is displayed by an application program to confirm that the instruction has been received and is being implemented. Server 410 may be configured to confirm such activities in other manners, such as by sending electronic e-mail or text messages, sending instructions for printing and mailing of physical letters to account owners, and other suitable methods.

By way of further example, the server 410 may be configured to generate and display administration system screen 486 on laptop 484 to a suitably authenticated user, such as an employee of the insurance company. The administrative system may show owner, annuitant, beneficiary and broker information, as stored in annuity account database 450, for an insurance company employee to review, verify or update, such as on issuing of a new annuity, or in response to a telephone inquiry from an annuity owner or broker.

A properly authenticated individual, such as an employee of an insurance company having administrative responsibilities, may access further data and provide updates and modifications to data, such as guaranteed rate data that the insurance company is contractually permitted to change. Other data that the insurance company may be contractually permitted to change and that may be updated by an insurance company employee may include fixed rates, threshold inflation rates, and participation rates, by way of example. Such a properly authenticated user may further be able to implement updates to processing logic. In embodiments of the present invention, one or more of the above modules, may also be implemented in combinations of software and hardware for execution by various types of computer processors coupled to such hardware.

As used herein, a module of executable code may, for instance, comprise one or more physical or logical blocks of computer instructions which may, for instance, be organized as an object, procedure, process or function. Nevertheless, the executables of an identified module need not be physically located together, but may comprise separate instructions stored in different locations which, when joined logically together, define the module and achieve the stated purpose for the module such as implementing the determination of amounts to be credited to an fixed annuity account responsive to receipt of data indicative of consumer price index value changes, as well as other business rules logic prescribed by the present system. In embodiments of the present invention a module of executable code may be a compilation of many instructions, and may be distributed over two or more different code partitions or segments, among different programs, and across two or more devices. Similarly, data, including by way of example annuity data, index data, and hedging instrument data, may be identified and illustrated herein within modules, and may be embodied in any suitable form and organized within any suitable type of data structure. Such data may be collected as a single data set, or may be distributed over different locations including over different storage devices, and may exist, at least partially, merely as electronic signals on a system and/or network as shown and described herein.

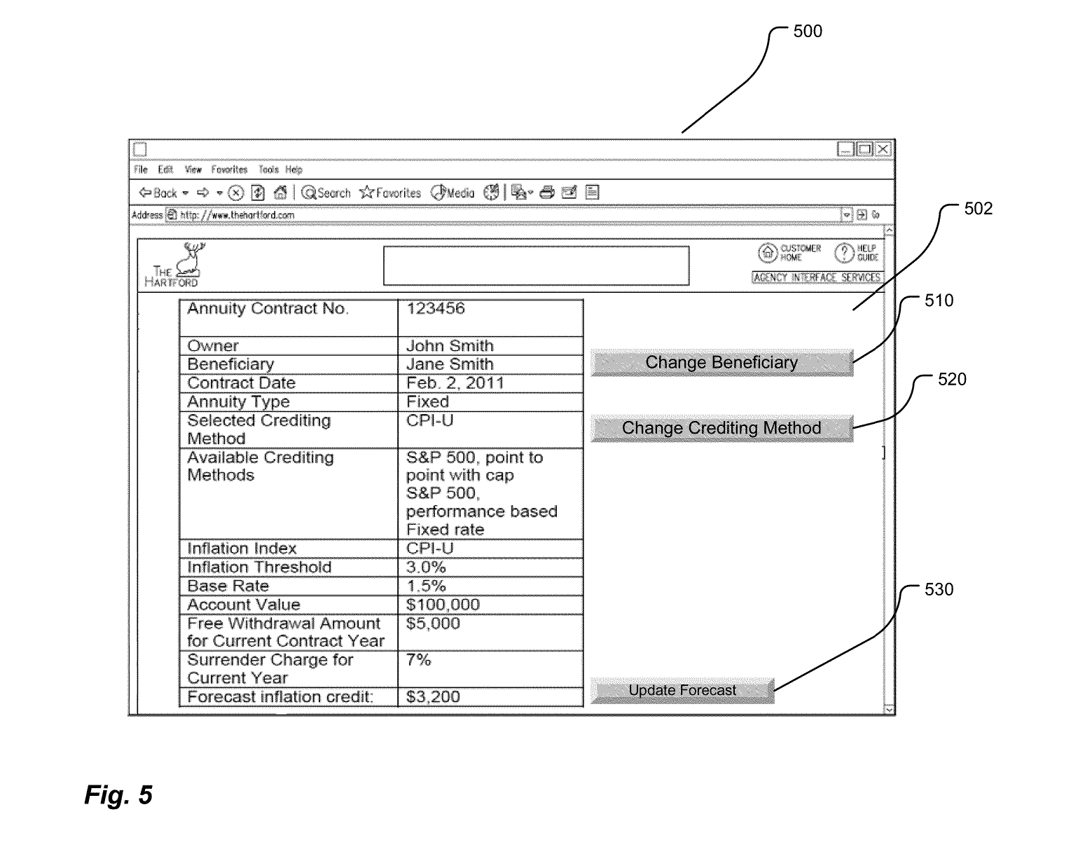

Referring to FIG. 5, in an embodiment, a computer server or client computer 500 running a client application such as a Web browser or a thick client application renders a graphical user interface, such as a series of screens to permit a user, such as an annuity owner, to view data, as shown on display 502, related to an annuity, including current account value, beneficiary, owner, indexes used, account anniversary date, and related data. In an embodiment, the display may include a button 510 to initiate a process to change a beneficiary or data, such as address data, associated with a beneficiary, a button 520 to permit a user to change a crediting method, and a button 530 to initiate an updated calculation of a forecast of the amount to be credited at the end of the current crediting period (e.g., on the next contract anniversary) as a result of consumer price index crediting methodology. The system may be configured to incorporate links and tabs to permit the user to access additional information and tools, such as tools to provide illustrations based on past equity index and consumer price data, and tools to provide illustrations based on various assumptions about consumer price index data. The links and tables may be configured to permit a user to implement actions such as withdrawals, printing statements, updating owner address information, and the like. The system may be configured to provide one or more alerts and messages, such as messages advising that a new base rate has been set for the next crediting calculation, that a new amount has been credited to the account, a deadline to change a crediting method for the next crediting period, or other alerts and messages.

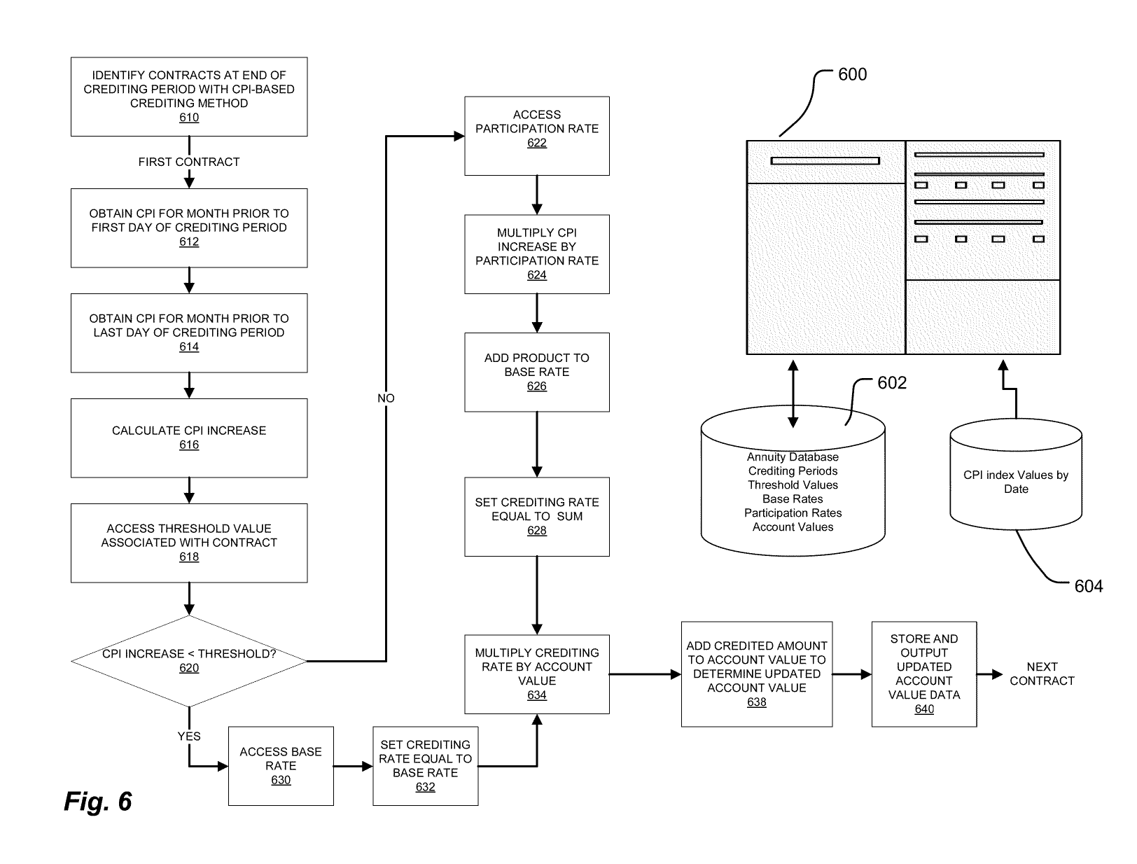

Referring to FIG. 6, a process flow of data processing steps performed by system server 600, which is in communication with annuity database 602 and CPI index database 604, will be shown. It will be appreciated that one or more steps performed in the process flow of FIG. 6, and other data processing flows, may be replaced by manually-implemented steps.

Referring again to FIG. 6, the system 600, such as on a batch basis every business day, identifies 610 all annuity contracts in annuity database 602 which have reached an end of a crediting period. A crediting period may be a contract year, or a longer or shorter period. The system then identifies all annuity contracts using a CPI-based crediting method, according to data associated with the annuity contracts and accessed from the annuity database 602, for example. For the first such contract identified, the system 600 then obtains 612 the appropriate CPI data for the month prior to the first day of the crediting period, such as from CPI database 604. Throughout these processing steps, the accessed values and calculated values may be stored in temporary memory locations, such as in RAM. The system then obtains 614 the CPI for the month prior to the last day of the crediting period and stores the data in a temporary memory location. The system then calculates 616 the CPI increase (or decrease) by dividing the value for the month prior to the last day of the crediting period by the value for the month prior to the first day of the crediting period, and subtracting 1 from the resulting value. The system then accesses 618, such as from annuity database 602, the threshold value of the increase in the CPI associated with the first contract. The system then compares 620 the determined CPI increase to the threshold value. If the CPI increase is not less than the threshold value, then the process flow proceeds to the system accessing 622 the participation rate from annuity database 602 associated with the first contract. The system then multiplies 624 the determined CPI increase by the participation rate. Of course, if the participation rate is equal to unity, then this multiplying step may be omitted. The product of the CPI increase and the participation rate is then added 626 to the base rate, which has been accessed from the annuity database 602. The sum of the base rate and the product of the CPI increase and the participation rate is then set 628 as the crediting rate.

If the CPI increase is less than the threshold, then the base rate is accessed 630, and the crediting rate is set 632 equal to the base rate.

The crediting rate is multiplied 634 by the account value, accessed from annuity database 634. The account value may be the account value as of the last day of the crediting period. This account value may be determined by taking the account value as of the first day of the crediting period, subtracting withdrawals and surrender charges, adding premiums paid, and increasing or decreasing for any market value adjustments. In embodiments, the account value employed may be a value based on values during the year, such as an average account value, taken on each business day, the last day of each calendar month, the date during each month of the contract anniversary, by way of example.

The CPI credits are then added to the account value to determine 638 an updated account value. The system then stores 640, such as in annuity database 602, the updated account value data, and further outputs the data, such as to a client communications system to provide printed and/or electronic statements, e-mails, text messages and other communications of data including the updated account value. The system then proceeds to perform the process flow with respect to the next contract identified as having reached the end of a crediting period and using the CPI-based crediting method. If the last contract identified as having reached the end of the crediting period and using the CPI-based crediting has been processed, then the batch processing is completed, and the system may store and output data indicative of completion of the batch for the current cycle.

The system 600 may also, on a batch basis, select those annuities having an associated equity index based crediting method. For those annuities, system 600 may determine an equity index crediting rate, using the change in the equity index from the first day to the last day of the crediting period, and the appropriate methodology associated in the annuity database, such as point to point with cap or performance trigger, and then multiplies the determined equity index crediting rate by the account value to determine an amount to be credited as a result of equity index performance. This value may be zero, for example in cases where the index value declined during the crediting period. Similarly, for other crediting methods, such as fixed rate, the system 600 may calculate a change in account value on a daily batch basis. Once the calculation of the change, if any, in account value for each annuity reaching the end of the crediting period is completed, the batch process is completed.

A processor may provide the central processing unit (CPU) functions of a computing device on one or more integrated circuits. The term “processor” may include multi-core processors and central processing units including multiple microprocessors. The central processing unit functionality may be provided at one or more remote locations, such as through application service provider and cloud computing services.

In embodiments, a processor may provide an output signal having data indicative of one or more data items. An output signal may be carried either over a suitable medium, such as wire or fiber, or wirelessly. An output signal may transmit data from one device to another directly, such as over a bus of a computer system from a processor to a memory device, or indirectly, such as over multiple networks, and with intermediate steps of storage in a buffer or memory device and retransmission. Such an output signal may be provided by the processor to a bus of a computer system together with address data at a series of clock intervals. The address data may designate a destination device on a bus, by way of example. In embodiments, an output signal may be a signal output from a hardware communications device of a computer system to a network, such as a local area network, a wide area network, or a network of interconnected networks, such as the Internet. Output signals may include, by way of example, data identifying formats, fields, and content of fields. Signals may be compatible with any appropriate format. For example, data may be formatted in accordance with a data format for insurance data, such as an ACORD compatible format, or a non-ACORD xml format. Reference to an output signal having particular data may include one or more signals bearing the information. Multiple signals bearing the information may include sequences of digital data bearing the information interleaved with sequences of digital data relating to other information. By way of example, a signal may be packetized for transmission. By way of further example, an output signal may take the form of an uncompressed digital signal or a compressed digital signal.

A system on which the methods of embodiments of the present invention may be implemented includes at least one central processing computer or computer network server. A network server includes at least one controller or central processing unit (CPU or processor), at least one communication port or hub, at least one random access memory (RAM), at least one read-only memory (ROM) and one or more databases or data storage devices. All of these later elements are in communication with the CPU to facilitate the operation of the network server. The network server may be configured in many different ways. For example, a network server may be a standalone server computer or alternatively, the functions of a network server may be distributed across multiple computing systems and architectures.

A network server may also be configured in a distributed architecture, wherein databases and processors are housed in separate units or locations. Some such servers perform primary processing functions and contain at a minimum, a RAM, a ROM, and a general controller or processor. In such an embodiment, each of these servers is attached to a communications hub or port that serves as a primary communication link with other servers, client or user computers and other related devices. The communications hub or port may have minimal processing capability itself, serving primarily as a communications router. A variety of communications protocols may be part of the system, including but not limited to: Ethernet, SAP, SAS™, ATP, Bluetooth, GSM and TCP/IP.

Data storage device may include hard magnetic disk drives, optical storage units, CD-ROM drives, or flash memory, by way of example. Data storage devices contain databases used in processing calculations embodied in algorithms, including data for display on client devices and data for determination of crediting rates and changes to annuity account values. In one embodiment, database software creates and manages these databases. Annuity and Insurance related calculations and/or algorithms in accordance with an embodiment of the present invention may be stored in storage devices and accessed and executed by a processor.

Suitable computer program code may be provided for performing numerous functions such as producing reports for review by insurance company personnel and auditors indicative of amounts credited to annuities based on inflation indexes, data relating to options purchased by the insurance company to fund the guaranteed credits, and other functions. The functions described above are merely exemplary and should not be considered exhaustive of the type of function which may be performed by the computer program code of embodiments of the present inventions.

The computer program code required to implement the above functions (and the other functions described herein) can be developed by a person of ordinary skill in the art, and is not described in detail herein.

The annuity administration server described herein may be in communication with systems including payment systems for effecting payments of withdrawals to owners. The annuity administration server may further be in communication with a server for administration of annuities during the payout phase, such that upon receipt of data indicative of an owner decision to annuitize, relevant data, such as current account value, can be transmitted to the server for administration of annuities during the payout phase for determination of a payout rate and determination, using the payout rate, the applicable payment period (single life, joint life, term of years, single life with a minimum term of years, or other period), demographic data as to annuitants, such as age and gender, at least for life terms, payment frequency (annual, quarterly, monthly or other), the account value, and any surrender charges or market value adjustments, the amount of each payment during the payout period can be determined.

The term “computer-readable medium” as used herein refers to any medium that provides or participates in providing instructions to the processor of the computing device (or any other processor of a device described herein) for execution. Such a medium may take many forms, including but not limited to, non-volatile media, non-transitory media, tangible media, volatile media, and transmission media. Non-volatile media and tangible media include, for example, optical or magnetic disks, such as memory. Volatile media include dynamic random access memory (DRAM), which typically constitutes the main memory. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM or EEPROM (electronically erasable programmable read-only memory), a FLASH-EEPROM, any other memory chip or cartridge, a carrier wave as described hereinafter, or any other medium from which a computer can read.

Various forms of computer readable media may be involved in carrying one or more sequences of one or more instructions to the processor (or any other processor of a device described herein) for execution. For example, the instructions may initially be borne on a magnetic disk of a remote computer. The remote computer can load the instructions into its dynamic memory and send the instructions over an Ethernet connection, cable line, or even telephone line using a modem. A communications device local to a computing device (or, e.g., a server) can receive the data on the respective communications line and place the data on a system bus for the processor. The system bus carries the data to main memory, from which the processor retrieves and executes the instructions. The instructions received by main memory may optionally be stored in memory either before or after execution by the processor. In addition, instructions may be received via a communication port as electrical, electromagnetic or optical signals, which are exemplary forms of wireless communications or data streams that carry various types of information.

Servers of embodiments of the present invention may also interact and/or control one or more user devices or terminals. The user device or terminal may include any one or a combination of a personal computer, a mouse, a keyboard, a computer display, a touch screen, LCD, voice recognition software, or other generally represented by input/output devices required to implement the above functionality. The program also may include program elements such as an operating system, a database management system and “device drivers” that allow the processor to interface with computer peripheral devices (e.g., a video display, a keyboard, a computer mouse, etc).

An exemplary advantage of a method and system of the present invention is that an investor may obtain the benefits of fixed index annuities, such as increases in account value as a result of equity index positive performance, with no reduction in account value as a result of equity index negative performance, while preserving an option to change the crediting methodology to a methodology based on consumer price inflation, and thereby mitigate the risk of loss of purchasing power as a result of above average inflation.

While particular embodiments of the invention have been illustrated and described, various modifications and combinations can be made without departing from the spirit and scope of the invention, and all such modifications, combinations, and equivalents are intended to be covered and claimed.

What is claimed is:

1. A computer system for processing data related to fixed annuities, comprising:
one or more data storage devices storing data associated with a plurality of fixed annuities and indicative of account values, a time period for crediting of interest, a crediting method including for each of the fixed annuities one of at least an equity index based crediting method and a price index based crediting method; and for each of the fixed annuities having an associated price index based crediting method, a participation rate, a threshold value of the price index increase, and a guaranteed rate;
an annuity administration hardware server, in communication via a network with sources of data as to price index values and equity index values, and configured to:
determine a price index crediting rate for each of the fixed annuities having a price index based crediting method based on the received price index value data, the threshold value, the participation rate, and the guaranteed rate;
calculate an updated account value for each of the fixed annuities having a price index based crediting method based on the price index crediting rate and the account values; and
provide output data indicative of the updated account value; and
a webserver in communication with the annuity administration server configured to receive at least the updated account value data and to permit a client device to access the updated account value data for display to a user.

2. The computer system of claim 1, wherein the annuity administration server is further configured to determine whether the threshold value of the price index value has been reached, and, responsive to determining that the threshold value of the price index value has not been reached, set the price index crediting rate equal to the guaranteed rate, and responsive to determining that the threshold value of the price index value has been reached, determine the price index crediting rate by multiplying the participation rate by the price index value and adding the guaranteed rate to a result of the multiplying.

3. The computer system of claim 2, wherein the data indicative of price index values comprises data indicative of a Consumer Price Index.

4. The computer system of claim 3, wherein the threshold value of the price index value is between 2% and 6%, inclusive.

5. The computer system of claim 3, wherein the participation rate is between 50% and 125%, inclusive.

6. The computer system of claim 1, wherein the annuity administration hardware server is further configured to:
determine an equity index crediting rate for each of the fixed annuities having an equity index based crediting method based on the received equity index value data;
calculate an updated account value for each of the fixed annuities having an equity index based crediting method based on the equity index crediting rate and the account values; and
provide output data indicative of the updated account value.

7. The computer system of claim 1, wherein the data indicative of equity index values comprises data indicative of a U.S. equity index.

8. The computer system of claim 1, further comprising a statement printing and mailing system configured to receive data indicative of updated account values from the annuity administration server and to print and mail statements.

9. The computer system of claim 1, wherein the annuity administration server is further configured to, in combination with the web server, cause a user device to prompt a user for selection of one of a plurality of crediting methods, including price index based; equity index based using a point to point with cap method; equity index based with a performance trigger; and fixed rate.

10. A computer-implemented method for processing data relating to fixed annuities, comprising:
receiving by an annuity administration hardware server via a network data indicative of price index values;
accessing by the annuity administration hardware server one or more data storage devices storing data associated with a plurality of fixed annuities and indicative of account values, a time period for crediting of interest, a crediting method including for each of the fixed annuities one of at least an equity index based crediting method and a price index based crediting method; and for each of the fixed annuities having a price index based crediting method, a participation rate, a threshold value of the price index increase, and a guaranteed rate;
determining by the annuity administration hardware server, for the time period for crediting of interest, for each of the fixed annuities having a price index based crediting method, a price index based crediting rate based on the received price index value data, the threshold, the participation rate, and the guaranteed rate;
calculating by the annuity administration hardware server an updated account value for each of the fixed annuities having a price index based crediting method based on the determined price index based crediting rate; and
providing by the annuity administration hardware server to a client communication system output data indicative of the updated account value.

11. The computer-implemented method of claim 10, wherein the client communication system comprises a webserver, and further comprising receiving by the webserver from the annuity administration hardware server the data indicative of the updated account value, and providing by the webserver the data indicative of the updated account value to a client device for display.

12. The computer-implemented method of claim 10, wherein the data indicative of the time period for crediting of interest is data indicative of a one-year period commencing on a contract anniversary date.

13. The computer-implemented method of claim 10, wherein the determining the price index based crediting rate comprises:
comparing a price index value increase to the threshold value of the price index value;
responsive to determining that price index value is at least equal to the threshold value of the price index value, determining the price index based crediting rate by multiplying the participation rate by the price index value and adding the guaranteed rate to a result of the multiplying.

14. The computer-implemented method of claim 10, wherein the determining the price index based crediting rate comprises:
comparing a price index value increase to the threshold value of the price index value;
responsive to determining that the threshold value of the price index value has been reached,
setting the price index based crediting rate equal to the guaranteed rate.

15. The computer-implemented method of claim 10, wherein the data indicative of the price index value comprises data indicative of the CPI-U issued by the U.S. Bureau of Labor Statistics.

16. The computer-implemented method of claim 10, wherein the client communication system is an annuity statement generation system, and further comprising printing and formatting for mailing an annuity statement.

17. A non-transitory computer-readable medium, the computer-readable medium having processor-executable instructions stored thereon relating to processing of data for fixed annuities, which instructions, when executed by the processor, cause the processor to:
receive via a network data indicative of price index values;
access one or more data storage devices storing data associated with a plurality of fixed annuities and indicative of account values, a time period for crediting of interest, a crediting method including for each of the fixed annuities one of at least an equity index based crediting method and a price index based crediting method; and for each of the fixed annuities having a price index based crediting method, a participation rate, a threshold value of the price index increase, and a guaranteed rate;
determine, for the time period for crediting of interest, for each of the fixed annuities having a price index based crediting method, a price index based crediting rate based on the received price index value data, the threshold, the participation rate, and the guaranteed rate;
calculate an updated account value for the each of the fixed annuities having a price index based crediting method based on the determined price index based crediting rate and the stored account value; and
provide to a client communication system output data indicative of the updated account value.

18. The non-transitory computer-readable medium of claim 17, wherein the instructions further cause the processor to determine whether the threshold value of the price index increase has been reached, and, responsive to determining that the threshold value of the price index increase has not been reached, set the price index based crediting rate equal to the guaranteed rate, and responsive to determining that the threshold value of the price index increase has been reached, determine the price index based crediting rate by multiplying the participation rate by the price index increase and adding the guaranteed rate to a result of the multiplying.

19. The non-transitory computer-readable medium of claim 17, wherein the instructions further cause the processor to:
receive equity index value data via a network;
determine an equity index crediting rate for each of the fixed annuities having an equity index based crediting method based on the received equity index value data;
calculate an updated account value for each of the fixed annuities having an equity index based crediting method based on the equity index crediting rate and the account values; and
provide output data indicative of the updated account value.

20. The non-transitory computer-readable medium of claim 17, wherein the instructions further cause the processor to provide output data to an annuity statement generation system for generation of statements including the updated account value.
